(19) United States
(12) Patent Application Publication
(10) Pub. No.: US 2011/0053053 A1
(43) Pub. Date: Mar. 3, 2011

(54) CELL HOLDER FOR FUEL CELL

(75) Inventors: Sébastien Desplobain, Le Versoud (FR); Gaël Gautier, Veretz (FR)

(73) Assignee: STMicroelectronics S.A., Montrouge (FR)

(21) Appl. No.: 12/679,266

(22) PCT Filed: Sep. 18, 2008
(86) PCT No.: PCT/FR2008/051675

§ 371 Date: Aug. 10, 2010

(30) Foreign Application Priority Data
Sep. 20, 2007 (FR) 0757703

(51) Int. Cl. H01M 8/02; H01M 8/00

(52) U.S. Cl. 429/532; 429/400; 205/640; 216/17

(57) ABSTRACT

A porous silicon wafer including, on its upper surface side, multiple recesses, this upper surface being coated with a porous silicon layer having pores smaller than those of the wafer bulk.

### CROSS REFERENCE TO RELATED APPLICATIONS

This application is a U.S. National Stage patent application of PCT application number PCT/FR2008/015675, entitled “Cell Holder for Fuel Cell”, filed on Sep. 18, 2007 which application claims priority to French patent application Ser. No. 07/57703, filed on Sep. 20, 2007, entitled “Fuel Cell Support,” which applications are hereby incorporated by reference to the maximum extent allowable by law.

### BACKGROUND OF THE INVENTION

1. Field of the Invention

The present invention relates to a fuel cell support and to a method for manufacturing such a support.

2. Discussion of the Related Art

Fuel cells using microelectronics techniques have been provided. Especially, US patent application N ^{o}2007/00072032 A1 published on Mar. 29, 2007, provides fuel cells formed on a silicon wafer comprising porous silicon pillars. FIG. 1 reproduces FIG. 4H of this prior application.

As illustrated in FIG. 1, a porous silicon layer 153 comprising raised areas 154, 155, and 156 extends on the upper surface of a silicon wafer 100. Porous silicon layer 153 forms the support of a fuel cell. A first conductive layer 160, a first catalyst layer 170, an electrolyte layer 171, a second catalyst layer 172, and a second conductive layer 180 successively extend on the upper surface of this support, and follow the shape of its raised areas. First conductive layer 160 forms the anode collector of the full cell and second conductive layer 180 forms the cathode collector thereof. Anode and cathode collector layers 160 and 180 comprise through openings across their entire surfaces. A contact (not shown) is provided on the lower surface of the fuel cell on anode collector layer 160 and a contact (not shown) is provided on cathode collector layer 180. The assembly of first catalyst layer 170, of electrolyte 171, and of second catalyst layer 172 forms the “active stack” of the fuel cell. In silicon wafer 100, in alignment with raised areas 154, 155, and 156 of porous silicon layer 153, are formed porous silicon pillars 150, 151, and 152 which enable conveying the hydrogen reaching the lower surface of silicon wafer 100 towards the upper surface thereof.

To operate the fuel cell, hydrogen is injected on the lower surface side of the support, and air (carrying oxygen) is injected on the upper surface side of the support. The hydrogen is “broken down” at the level of catalyst layer 170 to form, on the one hand, protons H⁺ which travel towards electrolyte layer 171 and, on the other hand, electrodes which travel towards anode collector 160. The H⁺ protons cross electrolyte layer 171 to reach catalyst layer 172 where they recombine with oxygen, coming from outside of the cell through the openings formed in conductive cathode layer 180, and with electrons. Conventionally, with such a structure, a positive voltage is obtained on cathode collector 180 (on the oxygen side) and a negative voltage is obtained on anode collector 160 (on the hydrogen side).

It should be understood that FIG. 1 is not to scale. In particular, silicon wafer 100 typically has a thickness ranging between 250 and 700 μm while the active stack of layers 171, 172, and 173 typically has a thickness on the order of from 30 to 50 μm.

### SUMMARY OF THE INVENTION

An embodiment of the present invention aims at a novel porous silicon fuel cell support, this support enabling improving, among others, the electrochemical efficiency per area unit of the cell.

Thus, an embodiment of the present invention provides a porous silicon wafer comprising, on its upper surface side, multiple recesses, this upper surface being coated with a porous silicon layer comprising pores smaller than those of the wafer bulk.

According to an embodiment of the present invention, the lower surface of the wafer is also coated with a porous silicon layer comprising pores smaller than those of the wafer bulk.

According to an embodiment of the present invention, the pores of the bulk of the wafer have dimensions greater than 50 nm and the pores of the porous silicon layers have dimensions ranging between 2 and 50 nm.

According to an embodiment of the present invention, the porous silicon layers have a thickness ranging between 1 and 20 μm.

An embodiment of the present invention provides a fuel cell formed on the upper surface of a porous silicon wafer such as described hereabove.

According to an embodiment of the present invention, the fuel cell comprises, on the upper porous silicon wafer, a superposition of a first conductive layer intended to be connected to an anode collector and having through openings, of a first catalyst layer, of an electrolyte layer, of a second catalyst layer, and of a second conductive layer intended to be connected to a cathode collector and having through openings.

An embodiment of the present invention provides a method for forming a porous silicon support wafer, comprising the steps of:

forming multiple recesses on the side of the upper surface of a lightly-doped N-type silicon wafer;

forming, on the raised areas of the upper surface of the silicon wafer, a layer more heavily N-type doped than the silicon wafer; and

performing an electrolysis of the silicon wafer, so that the wafer bulk is turned into porous silicon, and the heavily-doped layer is turned into porous silicon, the pores of the porous silicon layer being smaller than the pores of the bulk of the porous silicon wafer.

According to an embodiment of the present invention, before electrolysis, a silicon layer more heavily N-type doped than the silicon wafer is also formed on the side of the lower surface of the silicon wafer.

According to an embodiment of the present invention, the pores of the porous silicon wafer bulk have dimensions greater than 50 nm and the pores of the porous silicon layers have dimensions ranging between 2 and 50 nm.

An embodiment of the present invention provides a method for forming a fuel cell on a porous silicon wafer such as that described hereabove, further comprising the steps of:

depositing a first conductive layer intended to be connected to an anode collector on the recesses;

forming through openings in the first conductive layer;

successively performing, on the first conductive layer, depositions of a first catalyst layer, of an electrolyte layer, of a second catalyst layer, and of a second conductive layer intended to be connected to an anode collector; and

forming through openings in the second conductive layer.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1, previously described, illustrates a fuel cell formed on a known support;

FIG. 2 illustrates a fuel cell formed on a porous silicon support according to an embodiment of the present invention; and

FIGS. 3A, 3B, and 3D to 3F illustrate results of steps of a method for manufacturing a porous silicon support according to an embodiment of the present invention, FIG. 3C being a top view corresponding to FIG. 3B.

### DETAILED DESCRIPTION

For clarity, the same elements have been designated with the same references in the different drawings and, further, as is usual in the representation of semiconductor structures, the various drawings are not to scale.

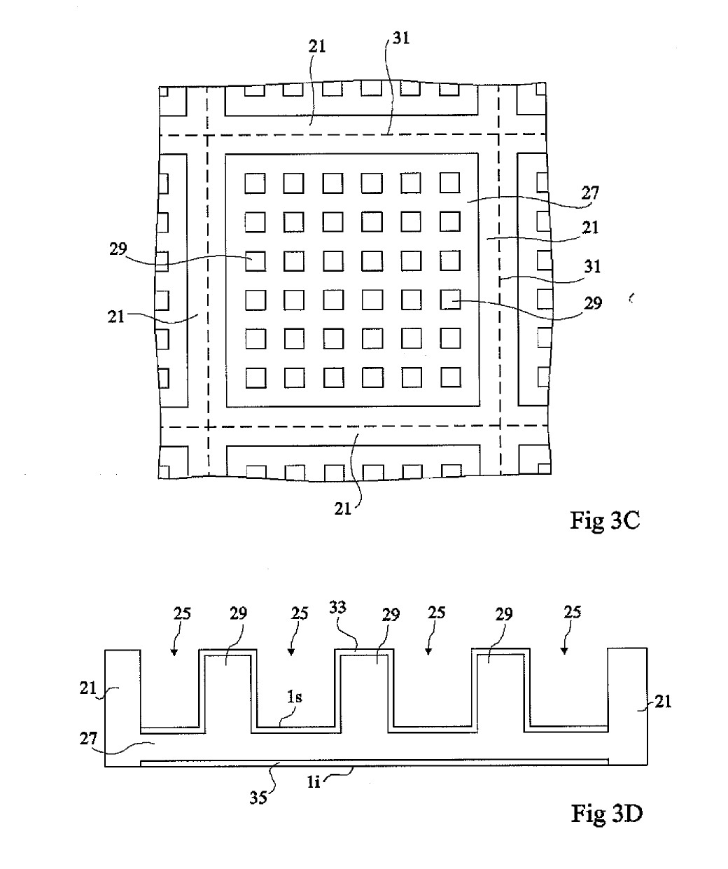

FIG. 2 illustrates a fuel cell formed on a support according to an embodiment of the present invention. Support 1 is formed from a macroporous silicon substrate 3 having its upper surface comprising many recesses or trenches 5. A mesoporous silicon layer 7 extends on the raised upper surface of macroporous silicon substrate 3. “Mesoporous” silicon is here used to designate porous silicon having pores with dimensions ranging between 2 and 50 nm and “macroporous” silicon is used to designate porous silicon having dimensions greater than 50 nm.

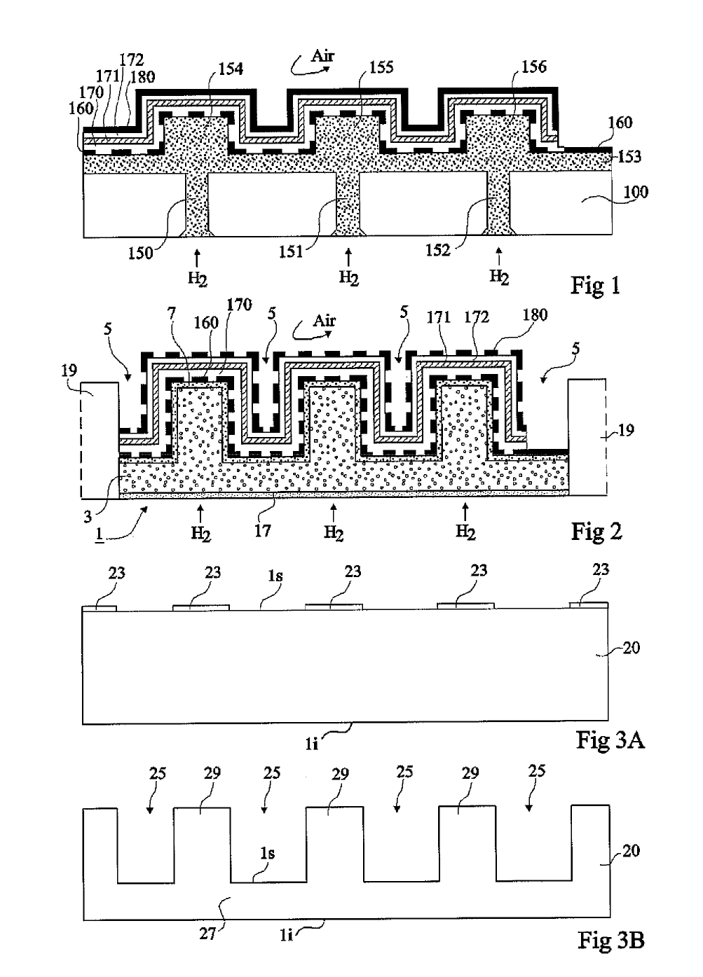

Layers forming a fuel cell are formed above mesoporous silicon layer 7, in the same way as previously described in relation with FIG. 1. Optionally, a thin mesoporous silicon layer 17 may be formed on the lower surface of macroporous silicon substrate 3.

Thick solid silicon portions 19 may be kept all around support 1 to form a solid frame around it. This results in solidifying the support structure, the porous silicon forming the support comprising very thin regions, which may be fragile.

To operate the fuel cell, the upper surface of substrate 3 is put in contact with a source of hydrogen under pressure and the upper surface of the fuel cell is put in contact with an oxygen source, for example, ambient air. The hydrogen crosses macroporous silicon substrate 3 and mesoporous silicon layer 7 to reach catalyst layer 170 via the openings formed in anode collector layer 160. When the thin optional mesoporous silicon layer 17 is formed, hydrogen first passes through the pores of this layer before reaching macroporous silicon substrate 3. The air, as for itself, passes through the openings formed in cathode collector layer 180 to reach catalyst layer 172.

The structure of the support illustrated in FIG. 2 has several advantages.
The association of macroporous silicon substrate 3 and of mesoporous silicon layer 7 enables better supply of the fuel cell with hydrogen. Indeed, the macroporous silicon substrate has large pores which enable rapidly conveying the hydrogen from the lower support surface to mesoporous silicon layer 7. The hydrogen pressure drop in this substrate is relatively small. Hydrogen reaches a substantially equal pressure across the entire lower surface of thin mesoporous silicon layer 7 and is thus regularly transmitted by said layer into the vertical and horizontal portions of catalyst layer 170. The exchange surface area between hydrogen and catalyst layer 170 is thus optimized.
Mesoporous silicon layer 7 also enables holding catalyst layer 170 in position. Indeed, in some prior configurations, it is necessary to provide an intermediary layer which avoids that catalyst layer 170 penetrates into the upper surface of the support, especially into pores of large dimensions of a porous silicon layer. Since the pores of mesoporous silicon layer 7 are very thin, catalyst layer 170 cannot penetrate into it and it is thus not necessary to provide a buffer layer.
The optional lower mesoporous silicon layer 17 allows regulation of the hydrogen flow arriving into macroporous silicon substrate 3. Indeed, hydrogen reservoirs being generally under pressure, it may be necessary to regulate their flow and especially to avoid jerks as they are put under pressure. Mesoporous silicon layer 17 fulfills this function.

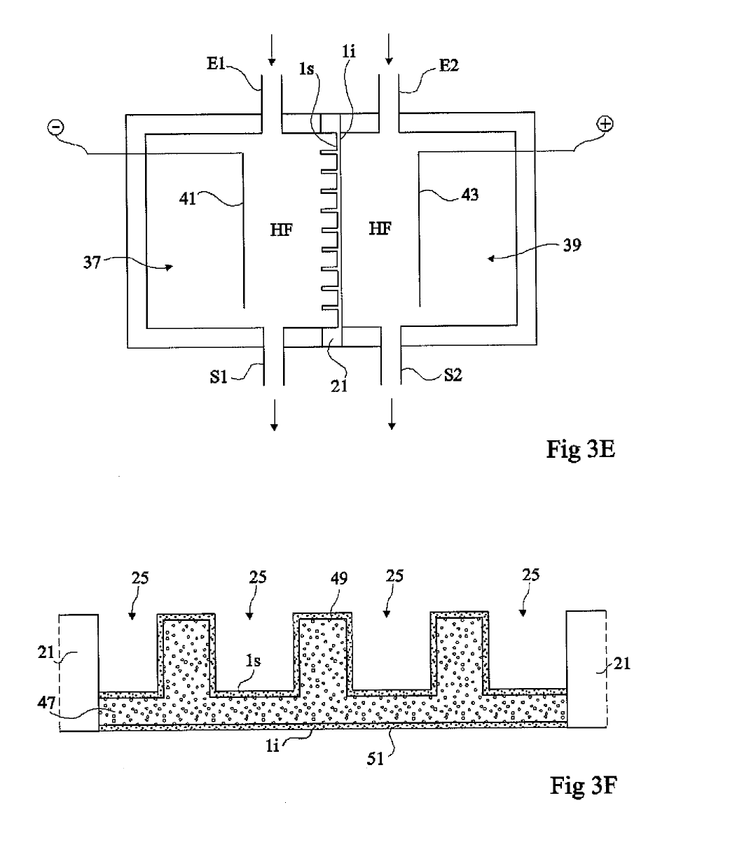

FIGS. 3A to 3F illustrate results of steps of a method for manufacturing a porous silicon fuel cell support according to an embodiment of the present invention. It should be noted that this support is generally formed on a portion only of a silicon wafer.

In FIG. 3A, it is started from a lightly-doped N-type silicon wafer 20. A mask 23 comprising adapted openings is formed on upper surface 1s of this wafer 20. As an example, the openings in mask 23 may have dimensions of approximately 50 μm.

At the step illustrated in FIG. 3B, multiple recesses or trenches 25 have been formed in silicon wafer 20 through the openings of mask 23. Silicon wafer 20 thus comprises a thinned area 27 topped with protrusions 29. As an example, the recesses may be formed by plasma etch and, as an example also, if silicon wafer 20 initially has a 300-μm thickness, thinned area 27 may have a thickness ranging between approximately 100 and 200 μm. Mask 23 is then removed.

FIG. 3C illustrates an example of a top view of the structure of FIG. 3B. In this view, the silicon wafer portion in which a fuel cell support is formed is delimited by a rectangle-shaped silicon frame 21 intended to be cut along a dotted line 31. Protrusions 29 are shaped as little squares and are regularly spaced apart at the level of thinned silicon area 27. As a variation, recesses 25 formed in the silicon wafer at the step of FIG. 3B may define different shapes of protrusions 29 above thinned silicon layer 27. As an example, in top view, protrusions 29 may have the shape of ribs.

At the step of FIG. 3D, an N-type doping on upper surface 1s of thinned layer 27 and on the top and the sides of protrusions 29 has been carried out, while protecting silicon frame 21 around thinned area 27, to obtain a thin heavily-doped layer 33. An N-type doping is optionally formed on lower surface 1i of thinned area 27 to obtain a heavily-doped thin layer 35. Such dopings may be obtained by phosphorus implantations followed by activation anneals. Also as an example, heavily-doped silicon layers 33 and 35 may have thicknesses ranging between approximately 1 and 20 μm.

At the next step, an electrolysis of the previously-obtained structure is performed, frame 21 being protected on both sides by appropriate masks. FIG. 3E shows an example of an adapted electrolysis mask which comprises two hydrofluoric acid baths 37 and 39 into which are dipped platinum electrodes 41 and 43, respectively connected to negative and positive terminals of a supply voltage. The hydrofluoric acid of baths 37 and 39 is regularly renewed via inlets E1 and E2 and outlets S1 and S2 of baths 37 and 39.

In this example, upper surface 1s of the wafer is in contact with bath 37 connected to the negative terminal and the other surface 1i of the wafer is in contact with bath 39 connected to the positive terminal.

As a non-limiting example, for a wafer having a 300-μm thickness, baths with a 30% hydrofluoric acid concentration and a 60-mA/cm² electrolysis current density may be used. The mesoporous and macroporous silicon may be formed with different current densities to improve the interface between the different layers.

As illustrated in FIG. 3F, there automatically results from the electrolysis step that the lightly-doped bulk 27, 29 (FIG. 3D) of the silicon wafer is turned into macroporous silicon 47 and that heavily-doped N-type surface layers 33 and 35 are turned into mesoporous silicon layers 49 and 51.

An advantage of having provided a heavily-doped N-type bulk and a heavily-doped N-type external layer is that, after electrolysis, a strong adherence between the macroporous silicon bulk and the external mesoporous layer is obtained.

The fuel cell support shown in FIG. 2 is thus obtained. Then, to form the fuel cell of FIG. 2, the following steps are carried out:
forming a first anode collector layer, for example, made of gold, extending on the raised areas of porous silicon layer 49;
forming through openings in the first anode collector conductive layer;
forming, successively, a first catalyst layer, an electrolyte layer and a second catalyst layer on the raised areas of the first conductive layer;
forming a second conductive cathode collector layer on the second catalyst layer;
forming through openings in the second conductive cathode collector layer; and
successive etchings of a small portion of the second conductive cathode collector layer, of the second catalyst layer, of the electrolyte layer, and of the first catalyst layer to form an access to the first conductive anode collector layer.

Specific embodiments of the present invention have been described. Various alterations and modifications will occur to those skilled in the art. In particular, it is possible to form the porous silicon support of FIG. 3F without forming mesoporous silicon layer 51 on the lower surface of the support. Indeed, as described previously, this layer is particularly advantageous in the case where the flow rate of the hydrogen reservoir needs to be regulated. If such is not the case, layer 51 may be unnecessary.

Further, the previously-described drawings only show a fuel cell. In practice, on the same wafer, a large number of cells which can then be assembled in series or in parallel, according to the desired use, may be formed.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A porous silicon support wafer for a fuel cell comprising, on its upper surface side, multiple recesses, this upper surface being coated with a porous silicon layer comprising pores smaller than those of the wafer bulk, said porous silicon layer following the shape of the recesses.

2. The porous silicon wafer of claim 1, wherein a lower surface of the wafer is also coated with a porous silicon layer comprising pores smaller than those of the wafer bulk.

3. The porous silicon wafer of claim 1, wherein the pores of the bulk of the wafer have dimensions greater than 50 nm and the pores of the porous silicon layers have dimensions ranging between 2 and 50 nm.

4. The porous silicon wafer of claim 1, wherein the porous silicon layers have a thickness ranging between 1 and 20 μm.

5. A fuel cell formed on the upper surface of the porous silicon wafer of claim 1.

6. The fuel cell of claim 5, comprising, on the upper porous silicon wafer, a superposition of a first conductive layer intended to be connected to an anode collector and having through openings, of a first catalyst layer, of an electrolyte layer, of a second catalyst layer, and of a second conductive layer intended to be connected to a cathode collector and exhibiting through openings.

7. A method for forming a porous silicon support wafer for a fuel cell, comprising the steps of:
forming multiple recesses on a side of the upper surface of a lightly-doped N-type silicon wafer;
forming, on the raised areas of the upper surface of the silicon wafer, a layer more heavily N-type doped than the silicon wafer; and
performing an electrolysis of the silicon wafer, so that the wafer bulk is turned into porous silicon, and the heavily-doped layer is turned into porous silicon, the pores of the porous silicon layer being smaller than the pores of the bulk of the porous silicon wafer.

8. The method of claim 7, wherein, before electrolysis, a silicon layer more heavily N-type doped than the silicon wafer is also formed on the side of the lower surface of the silicon wafer.

9. The method of claim 7, wherein the pores of the bulk of the porous silicon wafer have dimensions greater than 50 nm and the pores of the porous silicon layers have dimensions ranging between 2 and 50 nm.

10. A method for forming a fuel cell on a porous silicon wafer formed according to the method of claim 7, further comprising the steps of:
depositing a first conductive layer intended to be connected to an anode collector on the recesses;
forming through openings in the first conductive layer;
successively performing, on the first conductive layer, depositions of a first catalyst layer, of an electrolyte layer, of a second catalyst layer, and of a second conductive layer intended to be connected to an anode collector; and
forming through openings in the second conductive layer.
